(19) United States
(12) Patent Application Publication
(10) Pub. No.: US 2017/0269565 A1
(43) Pub. Date: Sep. 21, 2017

(54) METHOD AND APPARATUS TO ACQUIRE PARAMETERS OF GAS METERING

(71) Applicant: Honeywell International Inc., Morris Plains, NJ (US)

(72) Inventors: Chandrasekar Reddy Mudireddy, Hyderabad (IN); Suresh Kumar Palle, Bangalore (IN); Jaganmohan Y. Reddy, Hyderabad (IN); Surya Raichor, Hyderabad (IN)

(21) Appl. No.: 15/076,431

(22) Filed: Mar. 21, 2016

(51) Int. Cl. G05B 19/042; G06Q 30/04; G01F 1/00

(52) U.S. Cl. CPC G05B 19/042; G01F 1/00; G06Q 30/04; G05B 2219/25312

(57) ABSTRACT

A system and method access field device information in an industrial process control and automation system. The system includes a memory element configured to store a plurality of device data associated with a plurality of field devices operating at a pipeline. The system also includes at least one processor configured to communicate with one or more transmitters coupled to the plurality of field devices. The at least one processor is also configured to retrieve, from each of the one or more transmitters, the plurality of device data related to each of the plurality of field devices. The at least one processor is also configured to send a command to a field device of the plurality of field devices based on the plurality of device data.

### TECHNICAL FIELD

This disclosure relates generally to industrial measurement systems and industrial Internet of things. More specifically, this disclosure relates to an apparatus and method to acquire parameters of gas metering.

### BACKGROUND

Process plants are often managed using industrial process control and automation systems. Conventional control and automation systems routinely include a variety of networked devices, such as servers, workstations, switches, routers, firewalls, safety systems, proprietary real-time controllers, and industrial field devices. Often times, there is a need to have multiple measurement stations at different inlet points of a gas pipeline. Due to the cost and complexity, constraints on the number of measurement stations may result in the number of possible stations to be limited.

### SUMMARY

A first embodiment of this disclosure provides a system for accessing field device information in an industrial process control and automation system. The system includes a memory element configured to store a plurality of device data associated with a plurality of field devices operating at a pipeline. The system also includes at least one processor configured to communicate with one or more transmitters coupled to the plurality of field devices. The at least one processor is also configured to retrieve, from each of the one or more transmitters, the plurality of device data related to each of the plurality of field devices. The at least one processor is also configured to send a command to a field device of the plurality of field devices based on the plurality of device data.

A second embodiment of this disclosure provides a method for accessing field device information in an industrial process control and automation system. The method includes communicating with one or more transmitters coupled to a plurality of field devices operating at a pipeline. The method also includes retrieving, from each of the one or more transmitters, a plurality of device data related to each of the plurality of field devices. The method also includes sending a command to a field device of the plurality of field devices based on the plurality of device data.

A third embodiment of this disclosure provides a non-transitory computer readable medium containing computer readable program code that, when executed, causes at least one processing device to communicate with one or more transmitters coupled to a plurality of field devices operating at a pipeline. The computer readable program code, when executed, also causes the at least one processing device to retrieve, from each of the one or more transmitters, a plurality of device data related to each of the plurality of field devices. The computer readable program code, when executed, also causes the at least one processing device to send a command to a field device of the plurality of field devices based on the plurality of device data.

Other technical features may be readily apparent to one skilled in the art from the following figures, descriptions, and claims. Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may be provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example device for translating industrial process control and automation system events into mobile notifications according to this disclosure;

FIG. 3 illustrates an example system for remote analysis and control of field devices at a gas pipeline according to this disclosure; and

FIG. 4 illustrates an example process for accessing field device information in an industrial process control and automation system according to this disclosure.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

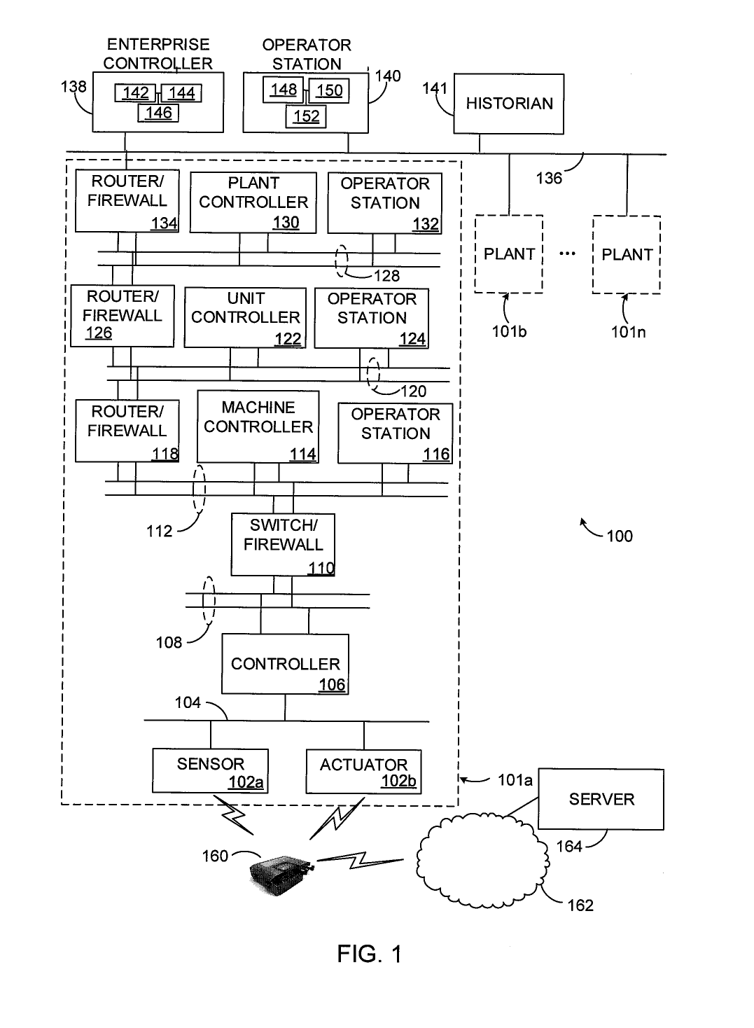

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b, which collectively may be referred to as field devices as used herein. These devices can be panel mounted purpose built computers such as flow computers. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS (FF) network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more enterprise desktops (also referred to as operator stations) 140. Each of the enterprise desktops 140 includes any suitable structure for supporting user access and control of one or more components in the system 100. Each of the enterprise desktops 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, and 138 could include one or more processing devices 142 and one or more memories 144 for storing instructions and data used, generated, or collected by the processing device(s) 142. Each of the controllers 106, 114, 122, 130, and 138 could also include at least one network interface 146, such as one or more Ethernet interfaces or wireless transceivers. Also, each of the operator stations 116, 124, 132, and 140 could include one or more processing devices 148 and one or more memories 150 for storing instructions and data used, generated, or collected by the processing device(s) 148. Each of the operator stations 116, 124, 132, and 140 could also include at least one network interface 152, such as one or more Ethernet interfaces or wireless transceivers.

One or more embodiments of this disclosure recognize and take into account that HONEYWELL SMARTLINE HART transmitters are designed for use with sensors 102a and actuators 102b in process industry to measure certain critical process measurements like pressure, temperature, level, flow, energy, etc. The transmitters are loop-powered devices and connect to hosts through a wired HART interface, FF or DE interface. Multiple devices can be connected to hosts (HONEYWELL EXPERION, third party distributed control systems (DCSs), etc.) at the same time. The user or the plant engineer can configure the transmitters remotely through the host.

If an issue is observed in a device, such as one of the sensors 102a or actuators 102b, at a customer place, then the customer may contact a technical assistance center (TAC) team. The TAC team gets information from the user and communicates it to the technology team. But this information is often limited, and sometimes the problem statement is at a very high level. Also even if more details can be obtained, the problem may be very difficult to reproduce as it may occur in a certain configuration that the TAC team might not have.

To replicate the issue, information from the customer that would be useful could include the actual device setup information, the sequence or the configuration steps by which the issue is arrived/reproduced, existing device diagnostics messages, current and past device configuration history, and/or the firmware versions.

Various embodiments of this disclosure provide a communication device 160, such as a transmitter or cellular modem, that connects to each sensor 102a or actuator 102b. In one embodiment, one communication device 160 may connect to multiple sensors 102a or actuators 102b. In other embodiments, a communication device may only connect to a single sensor or actuator.

The communication device 160 collects one or more diagnostics messages, error logs, customer configuration, and configuration history data from one or more of the sensors 102a and actuators 102b. The communication device 160 connects the sensors 102a and actuators 102b through a wired or wireless connection. In one embodiment, the communication device 160 includes more than one wireless communication interface. In this example, the communication device 160 may communicate with the sensor 102a or actuator 102b through one wireless protocol, such as such as a HART or FOUNDATION FIELDBUS (FF) network, and communicate with a cellular network using a second wireless protocol.

The communication device 160 may communicate the data received from the sensor 102a or actuator 102b over an Internet connection and update all of this information into a remote server 164 with the device serial number. Any current technology to store and sort this data on the host, such as cloud computing, can be used.

The communication device 160 communicates over the network 162 with the remote server 164. The network 162 generally represents any suitable communication network(s) outside the system 100 (and therefore out of the control of the owners/operators of the system 100). The network 162 could represent the Internet, a cellular communication network, or other network or combination of networks.

Although FIG. 1 illustrates one example of an industrial process control and automation system 100, various changes may be made to FIG. 1. For example, a control and automation system could include any number of sensors, actuators, controllers, operator stations, networks, servers, communication devices, and other components. In addition, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which information related to an industrial process control and automation system can be transmitted to a remote server. This functionality can be used in any other suitable system.

Transporting natural gas from wellhead to market involves a series of processes and an array of physical facilities. Among these are:

Gathering Lines—These small-diameter pipelines move natural gas from the wellhead to the natural gas processing plant or to an interconnection with a larger mainline pipeline.

Processing Plant—This operation extracts natural gas liquids and impurities from the natural gas stream.

Mainline Transmission Systems—Wide-diameter, long-distance pipelines transport natural gas from the producing area to market areas.

Market Hubs/Centers—Locations where pipelines intersect and flows are transferred.

Underground Storage Facilities—Natural gas is stored in depleted oil and gas reservoirs, aquifers, and salt caverns for future use.

A natural gas pipeline system begins at a natural gas producing well or field. In the producing area many of the pipeline systems are primarily involved in “gathering” operations. That is, a pipeline is connected to a producing well, converging with pipes from other wells where the natural gas stream may be subjected to an extraction process to remove water and other impurities if needed.

Once it leaves the producing area, a pipeline system directs flow either to a natural gas processing plant or directly to the mainline transmission grid. The principal service provided by a natural gas processing plant to the natural gas mainline transmission network is that it produces pipeline quality natural gas. The natural gas mainline (transmission line) is a wide-diameter, often-times long-distance, portion of a natural gas pipeline system, excluding laterals, located between the gathering system (production area), natural gas processing plant, other receipt points, and the principal customer service area(s). The lateral, usually of smaller diameter, branches off the mainline natural gas pipeline to connect with or serve a specific customer or group of customers.

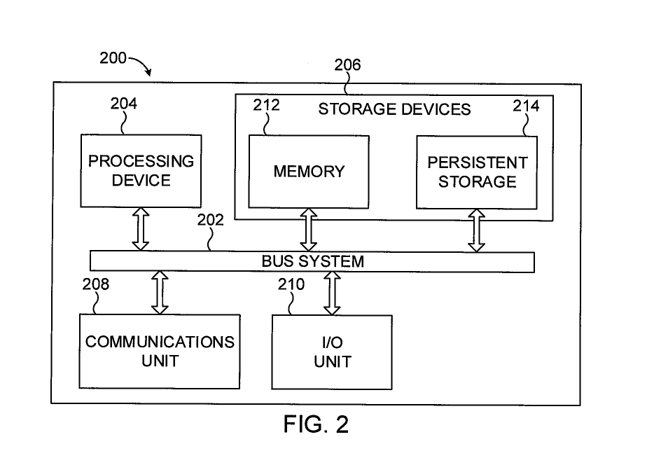

FIG. 2 illustrates an example device 200 for translating industrial process control and automation system events into mobile notifications according to this disclosure. The device 200 could represent, for example, the communication device 160 or the remote server 164 in the system 100 of FIG. 1. However, the communication device 160 could be implemented using any other suitable device or system, and the device 200 could be used in any other suitable system.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a ready only memory, hard drive, Flash memory, or optical disc.

The communications unit 208 supports communications with other systems or devices. For example, the communications unit 208 could include a network interface that facilitates communications over at least one Ethernet, HART, FOUNDATION FIELDBUS, cellular, Wi-Fi, universal asynchronous receiver/transmitter (UART), serial peripheral interface (SPI) or other network. The communications unit 208 could also include a wireless transceiver facilitating communications over at least one wireless network. The communications unit 208 may support communications through any suitable physical or wireless communication link(s). The communications unit 208 may support communications through multiple different interfaces, or may be representative of multiple communication units with the ability to communication through multiple interfaces.

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

When implementing the communication device 160, the device 200 could execute instructions used to perform any of the functions associated with the communication device 160. For example, the device 200 could execute instructions that retrieve and upload information to and from a transmitter or field device. The device 200 could also store user databases.

Although FIG. 2 illustrates one example of a device 200, various changes may be made to FIG. 2. For example, components could be added, omitted, combined, further subdivided, or placed in any other suitable configuration according to particular needs. Also, computing devices can come in a wide variety of configurations, and FIG. 2 does not limit this disclosure to any particular configuration of computing device.

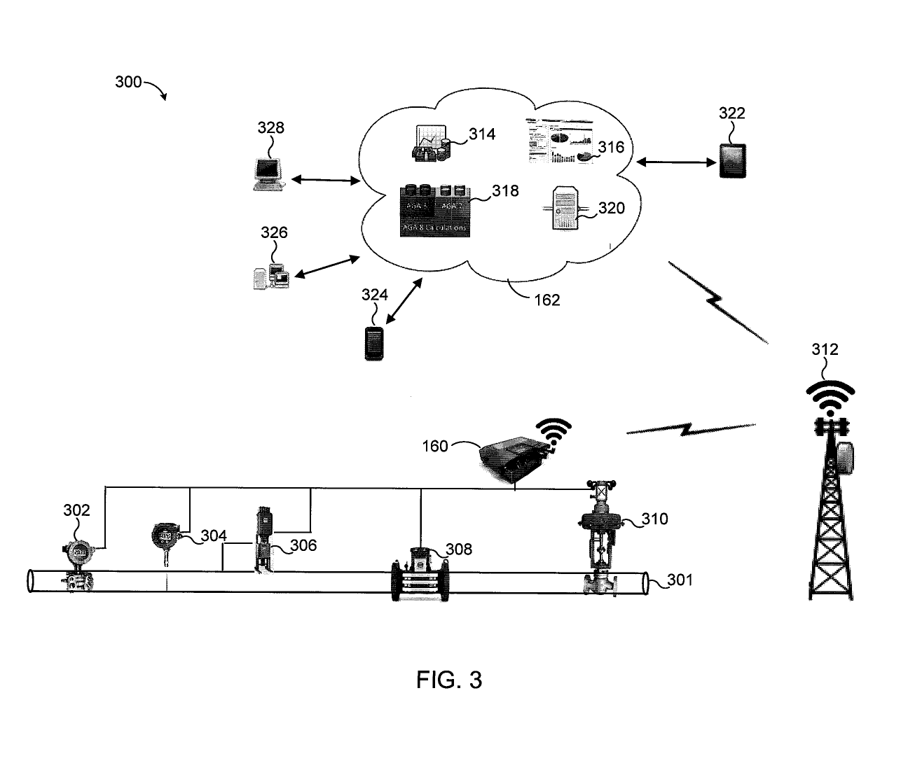

FIG. 3 illustrates an example system 300 for remote analysis and control of field devices at a gas pipeline 301 according to this disclosure. For ease of explanation, the system 300 is described as being supported by the industrial process control and automation system 100 of FIG. 1. However, the system 300 could be supported by any other suitable system.

In FIG. 3, system 300 includes a gas pipeline 301, field devices 302-310, communication device 160, cellular base station 312, network 162, billing module 314, monitor module 316, computing module 318, data collection module 320, tablets 322, smartphones 324, external servers 326, and computers 328. The field devices 302-310 can represent, or be represented by, any of the sensors 102a and actuators 102b as shown in FIG. 1. Collectively, billing module 314, monitor module 316, computing module 318, and data collection module 320 can be one example of server 164 in FIG. 1. Tablets 322, smartphones 324, external servers 326, and computers 328 can all be examples of user devices.

In one embodiment, the field devices 302-310 operate at the gas pipeline 301. In other embodiments, the gas pipeline 301 could be a liquid pipeline other type of pipeline. The field devices 302-310 may be configured to take measurements of the pipeline or the material in the pipeline. The field devices 302-310 may also be configured to affect the flow of gas or liquid in the pipeline.

In one or more embodiments, the field devices 302-310 may communicate with communication device 160 by a UART and/or SPI interface. The UART and/or SPI interface could be wired or wireless interfaces. When the communication device 160 connects to the field devices 302-310, the communication device 160 retrieves device data from the field devices 302-310. The communication device 160 can keep the record of the entire device configuration. The communication device 160 can track each configuration change in the field devices 302-310. The communication device 160 can monitor the firmware version compatibility and perform a regular firmware upgrade check. The communication device 160 can also monitor diagnostics, service life, and any alarm conditions of the field devices 302-310. Field devices can include flow computers can be operated by battery and can be in sleep to optimize the battery consumption. Flow computers can be field mounted or panel mounted and are powered by the external supply. A different version of the flow computers, called electronic volume collectors can be mounted on or near the sensor. These flow computers can be battery powered and operate in sleep mode for configured amount of time to save battery life.

In one example embodiment, field device 302 is a pressure sensor, field device 304 is a temperature sensor, field device 306 is a gas chromatograph, field device 308 is an ultrasonic sensor, and field device 310 is a control valve. Field devices 302-308 can be examples of a sensor 102a while field device 310 could be an example of an actuator 102b. The device data of the field devices 302-310 can include measurements from a pressure sensor, temperature sensor, gas chromatograph, ultrasonic sensors, and control valve. Communication device 160 can use a wireless interface to communicate with network 162 through cellular base station 312. These field devices can include flow computers.

Electronic gas flow computers are microprocessor-based computing devices used to measure and control natural gas streams. There is a variety of configurations available from dedicated (integrated) single board computers to PLC-based multi-run (hybrid) systems. Flow computers perform the following functions: compute volumetric flow of measured fluid, log measured and computed data, transmit real time and historical data to a central location, and perform automated control of the site based on measured values

In one example embodiment, billing module 314 can collect and organize billing data, monitor module 316 can organize the device data into visual charts and graphs, computing module 318 can be used to access the device data, and data collection module 320 can be used to store the device data. Tablets 322, smartphones 324, external servers 326, and computers 328 can be used to access the device data from network 162. Tablets 322, smartphones 324, external servers 326, and computers 328 can use billing module 314, monitor module 316, computing module 318, and data collection module 320 to access the device data.

Billing module 314, monitor module 316, computing module 318, and data collection module 320 can perform different computations using the device data from the field devices 302-310. The different modules 314-320 can be used to calculate volumetric flow of the measured fluid or gas, log measured data, check the accuracy and performance of the field devices (field devices can also be referred to as meters), check meter operations, perform sales meter operations, perform in-plant meter operations, provide access to raw data, measured data, alarms, events, and audits, provide peer to peer communication of soft flow computers for communication exchange, and track gas consumption and gas meters from a well to a burner. The cellular base station 312 and network 162 can use an Internet of Things protocol (e.g., message queue telemetric transport—MQTT). The computed data can include computed meter data, billing data, diagnostics data, and the like.

In an embodiment of this disclosure, HONEYWELL SMARTLINE transmitters can provide high-level fault information in device status information. The communication device 160 can read this information and update it in network 162. Based on this information, personnel can get detailed fault information at an earlier stage.

One or more embodiments of this disclosure recognize and take into account that if the issue is only related to a database loss or a wrong configuration or software issue, then the tablets 322, smartphones 324, external servers 326, and computers 328 can access the latest device data.

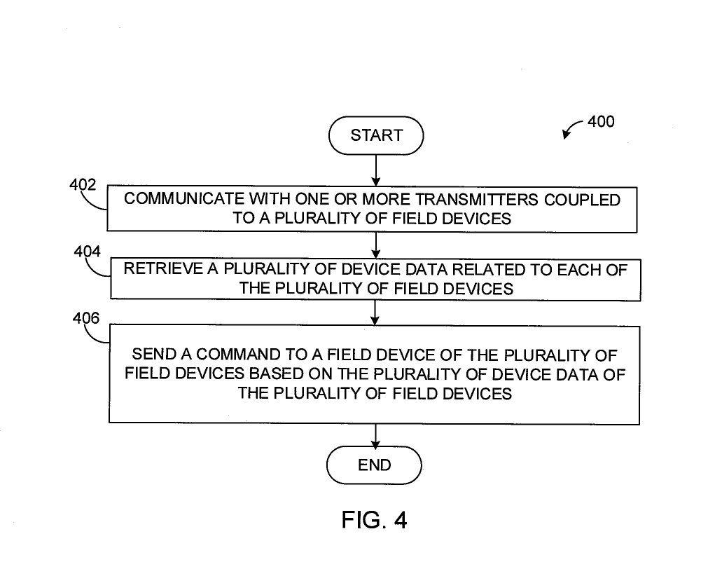

FIG. 4 illustrates an example process 400 for accessing field device information in an industrial process control and automation system according to this disclosure. A processing device, such as a controller, processor, or processing circuitry, can implement different operations in FIG. 4.

As shown in FIG. 4, at operation 402, a processing device is configured to communicate with one or more transmitters coupled to a plurality of field devices along a gas pipeline. The field devices operate in an industrial process and automation system. The field devices could measure a wide variety of characteristics in the process system, such as temperature, pressure, or flow rate. In one example embodiment, the devices communicate over a wired interface using one of a HART or FOUNDATION FIELDBUS protocol. The transmitter can be a cellular modem, a SMARTLINE transmitter, or a combination thereof.

At operation 404, the processing device is configured to retrieve, from each of the one or more transmitters, the plurality of device data related to each of the plurality of field devices. In this example, “retrieve” could be defined as “receive” or “request.” Once the device data is received, the processing device may perform calculations based on the device data, such as, for example, the volumetric flow of the gas. Based on these computations and calculations, the processing device can determine actions to be taken on other field devices along the gas pipeline. In one or more embodiments, device computations can be performed at a remote place, such as the server 164. In this manner, physical meters can be replaced with soft meters. The different computation instances can be reused across a pipeline.

At operation 406, the processing device is configured to send a command to a field device of the plurality of field devices based on the plurality of device data of the plurality of field devices. The command can be based on the determined actions, which is based on the device data. For example, the command can be for an actuator or valve to open or close. As another example, the command can be to request additional information from one or more of the field devices.

Although FIG. 4 illustrates one example of a process 400 for accessing field device information in an industrial process control and automation system, various changes may be made to FIG. 4. For example, while FIG. 4 shows a series of steps, various steps could overlap, occur in parallel, occur in a different order, or occur any number of times. In addition, the process 400 could include any number of events, event information retrievals, and notifications.

One or more embodiments of this disclosure provide that device computations can be performed at a remote location, such as a cloud or remote device. Physical meters can be replaced with soft meters. A single computation instance can be reused across the gas pipeline.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a memory element configured to store a plurality of device data associated with a plurality of field devices operating at a pipeline;
at least one processor configured to:
communicate with one or more transmitters coupled to the plurality of field devices;
retrieve, from each of the one or more transmitters, the plurality of device data related to each of the plurality of field devices; and
send a command to a field device of the plurality of field devices based on the plurality of device data.

2. The apparatus of claim 1, wherein one or more of the plurality of field devices is a sensor, and wherein the plurality of device data includes measurements from the sensor measuring attributes of a material in the pipeline.

3. The apparatus of claim 1, wherein the at least one processor is further configured to:
receive a request to access the plurality of device data from a user device; and
provide access to the plurality of device data.

4. The apparatus of claim 1, wherein the field device is an actuator, and wherein the command causes the actuator to open or close.

5. The apparatus of claim 4, wherein the actuator is a control valve.

6. The apparatus of claim 1, wherein the pipeline is one of a gas pipeline or liquid pipeline.

7. The apparatus of claim 1, wherein the command is a request for additional device data.

8. A method comprising:
communicating with one or more transmitters coupled to a plurality of field devices operating at a pipeline;
retrieving, from each of the one or more transmitters, a plurality of device data related to each of the plurality of field devices; and
sending a command to a field device of the plurality of field devices based on the plurality of device data.

9. The method of claim 8, wherein one or more of the plurality of field devices is a sensor, and wherein the plurality of device data includes measurements from the sensor measuring attributes of a material in the pipeline.

10. The method of claim 8, further comprising:
receiving a request to access the plurality of device data from a user device; and
providing access to the plurality of device data.

11. The method of claim 8, wherein the field device is an actuator, and wherein the command causes the actuator to open or close.

12. The method of claim 11, wherein the actuator is a control valve.

13. The method of claim 8, wherein the pipeline is one of a gas pipeline or liquid pipeline.

14. The method of claim 8, wherein the command is a request for additional device data.

15. A non-transitory computer readable medium containing computer readable program code that, when executed, causes at least one processing device to:
communicate with one or more transmitters coupled to a plurality of field devices operating at a pipeline;
retrieve, from each of the one or more transmitters, a plurality of device data related to each of the plurality of field devices; and
send a command to a field device of the plurality of field devices based on the plurality of device data.

16. The non-transitory computer readable medium of claim 15, wherein one or more of the plurality of field devices is a sensor, and wherein the plurality of device data includes measurements from the sensor measuring attributes of a material in the pipeline.

17. The non-transitory computer readable medium of claim 15, wherein the computer readable program code, when executed, further causes the at least one processing device to:
receive a request to access the plurality of device data from a user device; and
provide access to the plurality of device data.

18. The non-transitory computer readable medium of claim 15, wherein the field device is an actuator, and wherein the command causes the actuator to open or close.

19. The non-transitory computer readable medium of claim 18, wherein the actuator is a control valve.

20. The non-transitory computer readable medium of claim 15, wherein the pipeline is one of a gas pipeline or liquid pipeline.
